(19) United States
(12) Patent Application Publication
(10) Pub. No.: US 2010/0271273 A1
(43) Pub. Date: Oct. 28, 2010

(54) MOVABLE PART WITH AN INTEGRATED WAVEGUIDE FOR AN ELECTRONICS DEVICE

(76) Inventors: Anders Stjernman, Lindome (SE); Martin Nils Johansson, Molndal (SE); Patrik Persson, Grabo (SE); Jonas Frídén, Molndal (SE); Sven Anders Gösta Demeryd, Goteborg (SE)

Correspondence Address: ERICSSON INC., 6300 LEGACY DRIVE, M/S EVR 1-C-11, PLANO, TX, 75024, US

(21) Appl. No.: 12/808,854

(22) PCT Filed: Dec. 20, 2007
(86) PCT No.: PCT/EP2007/064283

§ 371 Date: Jun. 17, 2010

(51) Int. Cl. H01Q 1/24; H01Q 21/00; H01Q 9/06

(52) U.S. Cl. 343/702; 343/853; 343/700 MS

(57) ABSTRACT

A movable part for an electronic device which comprises at least two parts that can be moved in relation to each other. The movable part comprises a display for the electronic device and a first conducting plane which is comprised in the display or located adjacent to the display. The first conducting plane comprises a waveguide. The waveguide may be a co-planar waveguide, i.e. a waveguide which comprises a central strip of conducting material surrounded by slots on both sides.

### TECHNICAL FIELD

The present invention discloses a movable part for an electronic device that comprises at least two parts which can be moved in relation to each other.

### BACKGROUND

Modern electronic devices such as, for example, portable computers (“laptops computers”), or “clamshell” cellular telephones comprise two parts which can be moved relative to each other, with one of these parts comprising a display, usually a so called LCD (Liquid Crystal Display) or TFT (Thin film Transistor) display. Another example of an electronic device with two parts which can be moved relative to each other is cellular telephones where the two parts can slide relative to each other, as opposed to the rotating parts of the laptop computers or clamshell telephones.

These electronic devices with moving parts will usually comprise at least one antenna, but will usually have a rather large number of antennas, since a number of standards or frequency bands need to be accommodated. Examples of such standards are WLAN, Bluetooth, GPS, GPRS, UMTS etc, as well as different frequency bands which are used in different parts of the world.

In addition, there may also be a desire to equip a device with a plurality of antennas in order to obtain diversity reception and possibly also to take advantage of MIMO (Multiple Input Multiple Output) technology.

In conclusion, it can be stated that modern electronic devices usually need to be equipped with a number of different antennas. Usually, these antennas are placed in the part of the device which also comprises the display, usually at or around the edges of the device, e.g. on and around the lid in the case of a laptop computer.

The antennas will be connected to electronics in the device by means of cables which extend behind the display in order to reach the antennas, each antenna being connected to electronics by at least one cable. Thus, with a large number of antennas, as required by modern devices, there will also be a large number of cables, and there is a risk of making errors when connecting the antennas to the cables.

### SUMMARY

As explained above, there is thus a need for a solution by means of which antennas in a moving part in an electronic device can be connected to electronics in a better manner than previously.

In addition, since the large number of cables leading to and from the antennas involved in modern electronic devices will also become cumbersome since they are usually installed behind the display of the device, the solution should also be more compact than previous solutions.

Such a solution is offered by the present invention in that it discloses a movable part for an electronic device which comprises at least two parts which can be moved in relation to each other, so that the movable part of the invention is one of said parts.

The movable part of the invention comprises a display for the electronic device, as well as comprising a conducting plane which is comprised in the display or located adjacent to the display.

In the movable part of the invention, the first conducting plane comprises a waveguide. By means of this waveguide, antennas in or around the display can be connected to electronics which are housed in other parts of the electronic device, and since the waveguide or waveguides will be housed in one and the same plane, there is little or no risk of mistakes during installation.

Also, most displays, such as LCD or TFT displays house a conducting plane as a back layer of the display. If this back layer of the display is used as the conducting layer of the invention, the waveguides can be housed in the display unit as such, thus making the cabling both simpler and of less volume than in previous solutions.

In one embodiment of the invention, the waveguide is a so called co-planar waveguide, i.e. a waveguide which comprises a central strip of conducting material surrounded by slots on both sides. Such a waveguide can easily be created in a back layer of a TFT or LCD display, or in a sheet which is housed behind the display.

As has been explained, the waveguide of the invention is suitably used to obtain a connection between an antenna which is attached to the movable part and electronics such as a send and/or receive module.

These and other advantages of the present invention will become even more apparent from the following detailed description of the invention.

### BRIEF DESCRIPTION OF THE DRAWINGS

The invention will be described in more detail in the following, with reference to the appended drawings, in which

FIG. 1 shows an example of a device in which the invention may be used, and

FIG. 2 shows a front view of a first embodiment of the invention, and

FIG. 3 shows a cross section of the device of FIG. 2 along the line III-III, and

FIG. 4 shows a version of the embodiment of FIG. 3, and

FIG. 5 shows a front view of a second embodiment of the invention, and

FIG. 6 shows a front view of a third embodiment of the invention, and

FIG. 7 shows a front view of a fourth embodiment of the invention, and

FIG. 8 shows an exploded view of another embodiment of the invention, and

FIG. 9 shows a cross section of the embodiment of FIG. 8, and

FIG. 10 shows a front view of another embodiment of the invention, and

FIGS. 11 and 12 show different cross sections of the embodiment of FIG. 10, and

FIG. 13 shows a flow chart of a method of the invention, and

FIG. 14 shows an exploded view of a device in which the in invention is applied.

### DETAILED DESCRIPTION

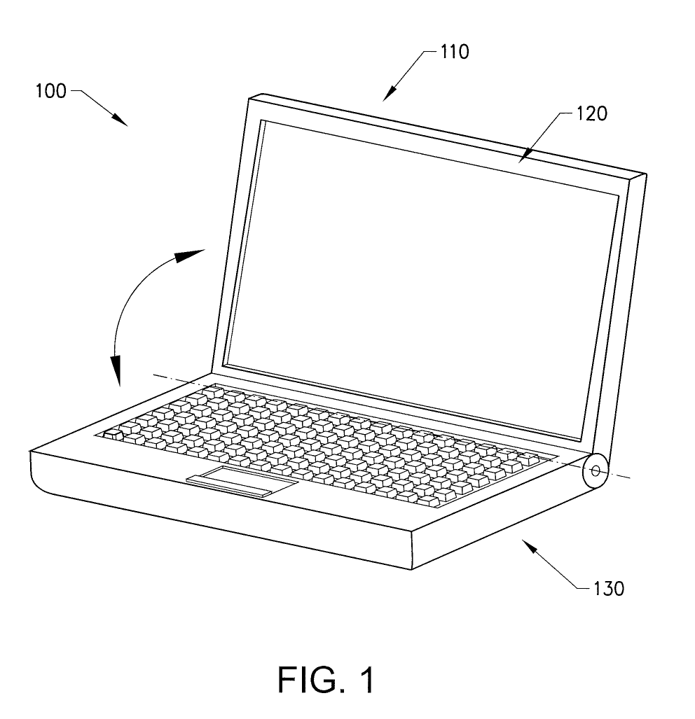

FIG. 1 shows an example 100 of an electronic device in which the present invention may be used. As can be seen in FIG. 1, the device which is used to exemplify the invention is a laptop computer 100 which comprises a chassis 130 in which there is a keyboard, and also comprises a lid 110 which houses a display 120. As indicated by means of a curved arrow, the lid 110 and the chassis may be moved relative to each other; in the case of the laptop computer they are rotatable with respect to each other.

It should be pointed out immediately that the device 100 shown in FIG. 1, i.e. a laptop computer, is merely an example of a device in which the present invention may be used, and is in no way intended to restrict the scope of protection of the invention. The invention may be applied in a wide variety of electronic devices which have two or more parts that may be moved in relation to each other, and which comprise a display.

Returning now to the exemplary device of FIG. 1, a display such as the flat kind of display used in most modern electronic devices, e.g. LCD or TFT displays, will usually comprise a back layer which is made of a conducting material. According to the invention, this back layer is utilized in order to house one or more waveguides, as will be shown in the following. However, if the display as such does not have a back layer which is conducting, a conducting plate can be arranged behind the display as such. In either case, since the waveguide or waveguides in the invention are housed in one contiguous layer or sheet, the desired ease of installation will be obtained, as well as the desired “low bulk”-feature.

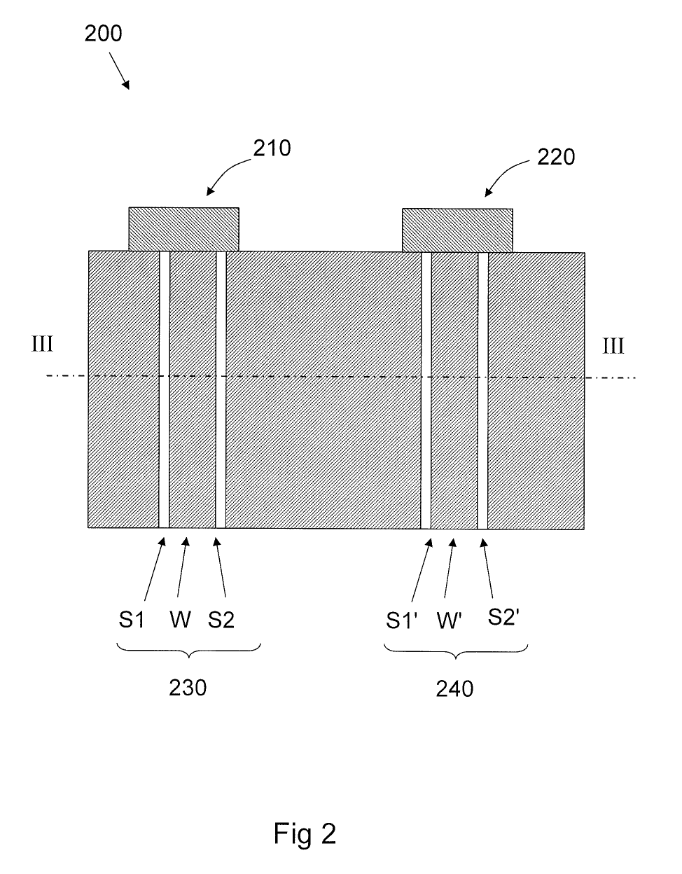

FIG. 2 shows a front view of a back layer or conducting layer 200 in a first embodiment of the invention. In order to facilitate the reader's understanding of the invention, the back layer is shown with two antennas 210 220, which are attached to the edges of the lid of the laptop computer of FIG. 1. However, in this embodiment, the antennas need not be part of the invention.

As is shown, the conducting layer 200 comprises a first and a second waveguide 230, 240, which are used to connect the antennas 210 and 220 to electronics which may be housed in, for example, the chassis 130 of the laptop computer 100 of FIG. 1. It should be pointed out that the number of waveguides (and antennas) shown in FIG. 2 and described here are merely examples; the number can be varied more or less arbitrarily, from one and upwards. Also, each antenna can be connected to more than one waveguide.

The waveguides 230, 240, are suitably so called coplanar waveguides, i.e. a waveguide which comprises a central strip, shown as W and W′ in FIG. 2, the central strip being surrounded on each side by a slot (shown as S1, S2, S1′, S2′ in FIG. 2. If the slots of the waveguide or waveguides extend along the entire length of the layer 200, a layer of non conducting material may suitably be arranged on one side of the layer 200, for mechanical reasons.

The antennas 210, 220 may, for example, be connected to the waveguides 230, 240, by means of a coaxial contact which has a transition with a centre conductor that contacts the centre strip W, W′, of the respective waveguide, or as an alternative, the antennas 210, 220, may be of a more advanced kind which can be excited by the centre strip of a waveguide. In such a case, the centre strip of the waveguide is merely extended to allow it to extend into the antenna.

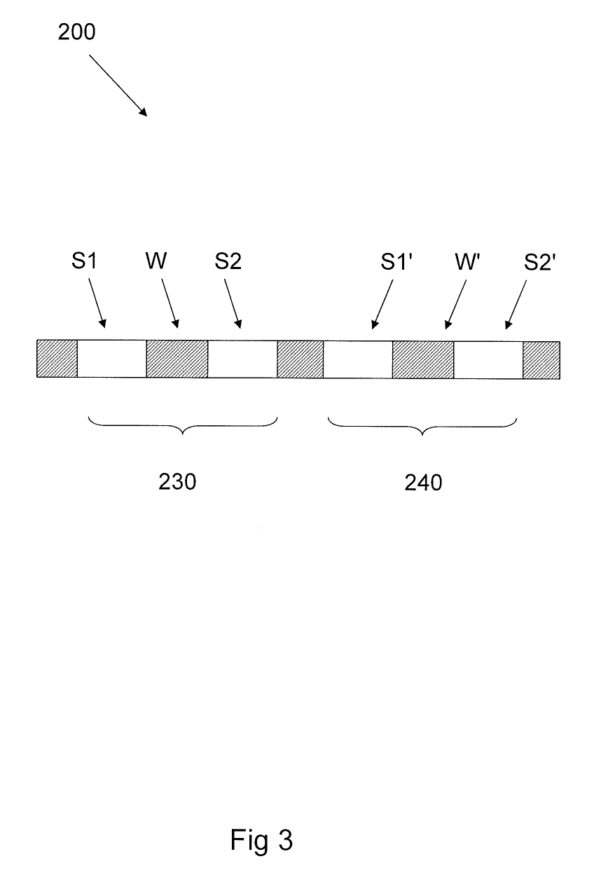

FIG. 3 shows a cross sectional view of the layer 200 of the invention along the line III-III shown in FIG. 2. In this view, the design of the waveguides 230, 240, can be seen even more clearly. As seen here, and also in FIG. 2, each waveguide comprises a centre strip W, W′, with a certain width, and is surrounded by slots S1, S2; S1′, S2′. The characteristic impedance of the waveguide will be determined by the ratio W/(2S+W), where W is the width of the centre conductor, and S is the width of the slots.

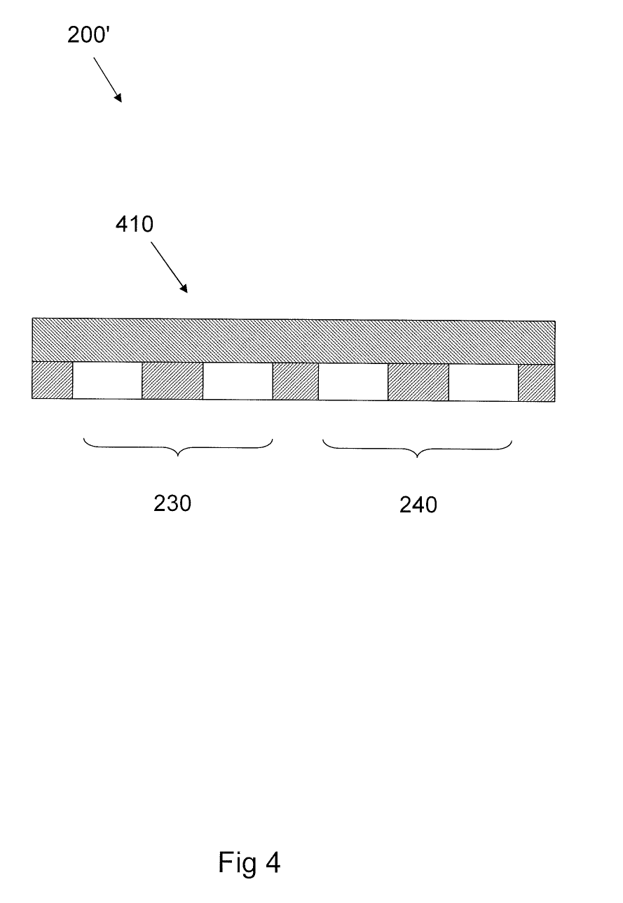

FIG. 4 shows a version 200′ of the back layer 200 of FIG. 3. This embodiment 200′ may be used if the slots of the waveguides extend through the entire length (or width or breadth) of the back layer, or at least sufficiently far so as to make the back layer in need of mechanical stabilization. In such a case, as shown in FIG. 4, a layer of non-conducting, electrically transparent material may be arranged on one side of the back layer.

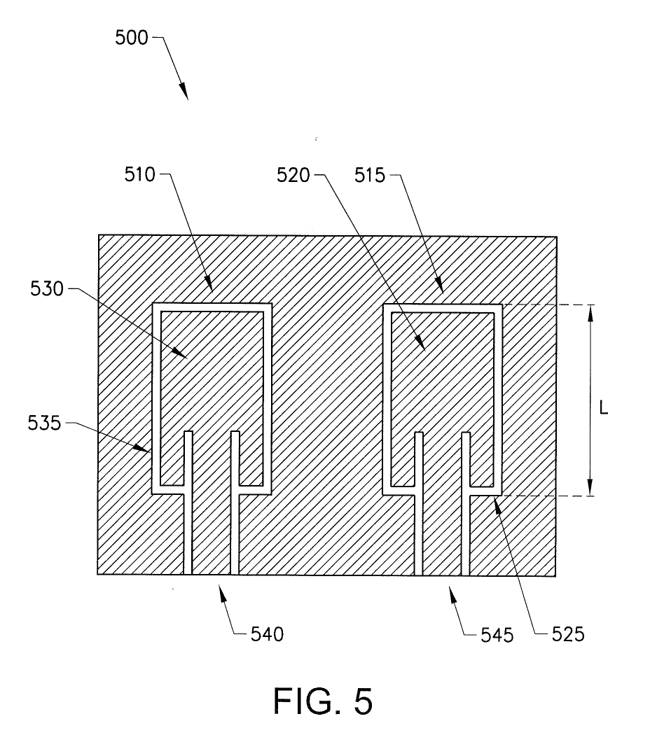

FIG. 5 shows a back layer 500 of a second embodiment of the invention. In this embodiment, the conducting layer or plane 500 comprises at least one antenna element, in the example shown in FIG. 5 there are two such elements 510, 515 shown. As is also shown in FIG. 5, in this embodiment, the waveguides, here shown as 540 and 545, connect to the antenna element or elements 510, 515.

The antenna elements 510, 515, of the embodiment 500 are suitably so called patch antennas, i.e. patches which are created in the conducting material of the back layer 500. The antenna elements shown in FIG. 5 are examples of such patch antennas, with the patches shown in FIG. 5 being rectangular patch elements. As can be seen in FIG. 5, the patch elements have been created by making a slot 525, 535, around the area 520, 530, which is intended as the patch. As is also shown in FIG. 5, the respective waveguide 540, 545, of the antenna elements 510, 515, connects to the antenna element by having the waveguide extend a certain distance into the antenna element. The distance with which the waveguide extends into the antenna element is suitably varied using simulations and optimization so that good matching is obtained. The width of the antenna element may also be varied for this purpose.

Thus, in the embodiment of FIG. 5, the back layer as such incorporates one or more antenna elements 510, 515, to which the waveguide or waveguides 540, 545, connect. As can be realized this embodiment will provide for an extremely compact antenna design, which will naturally be highly advantageous in electronic devices such as laptop computers, cellular telephones etc.

Regarding the antenna elements 510, 515, of the embodiment 500, the rectangular patches shown in FIG. 5 are merely examples of a wide range of patch antennas, which as such will be known to the man skilled in the field, and which can be used in the present invention. Other examples of such patch antennas or patch elements are so called “slot loops”, where, as the name implies, the rectangular shape shown in FIG. 5 is replaced by a round or oval shaped patch which is surrounded by a slot, such as the slots 535, 525 of FIG. 5.

Regarding the operational frequency and bandwidth of the antenna elements, the length L (shown in FIG. 5) of the rectangles will be proportional to λ/2, where λ is the centre frequency of the frequency range in which the patch can operate.

The bandwidth of the patch or patches is determined by the width of the patch, i.e. the extension of the patch in a direction which is perpendicular to the length. A wider patch will provide a bigger bandwidth, but the length of the patch also needs to be adapted to the width, so that a wider patch will become shorter.

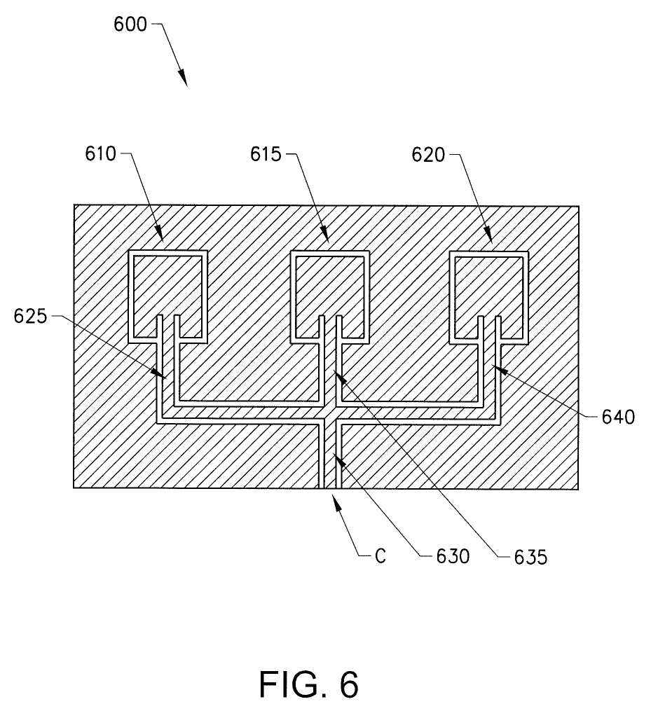

FIG. 6 shows another embodiment 600 of the back layer of the present invention. In similarity with the embodiments 400 and 500 of FIGS. 4 and 5, this embodiment comprises a number of antenna elements, the example in FIG. 6 comprising three such elements, 610, 615, 620. In the embodiment 600, the waveguide which is formed in the conducting back layer is shaped into a feeder network 630, which branches out into three branches 625, 635, 640, in order to connect to the antenna elements of the layer. By means of the feeder network 630, the antenna elements can thus be accessed for reception and/or transmission in one single common point, shown as C in FIG. 6. The antenna elements of the embodiment 600 may be the same as those described above in connection with the description of the other embodiments.

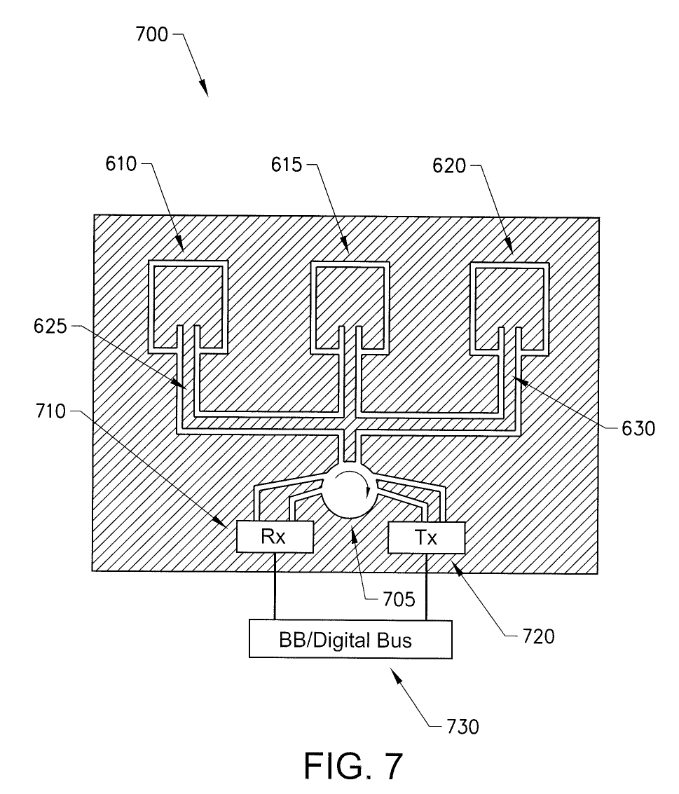

FIG. 7 shows a further embodiment of a back layer 700 of the invention. The embodiment 700 comprises a plurality of antenna elements which have been given the same reference numbers, 610, 615, 620, as those of the embodiment in FIG. 6. Also in similarity with the embodiment of FIG. 6, the back layer 700 comprises a feeder network 630 which branches out to the antenna elements of the layer. However, the embodiment 700 of FIG. 7 also comprises receive and/or transmit electronics in the back layer 700, here shown as 710, 720.

The role of the transmit and receive electronics can, for example, be modulation, demodulation, filtering, amplification or conversion between different kinds of bit streams.

If the receive and/or transmit electronics are incorporated into the back layer 700, as shown in the embodiment 700, this will naturally even further enhance the “low bulk” feature of the present invention.

One way of incorporating electronics into the back layer is to manufacture IC chips in so called thin film technique, and to then arrange the chips on the back layer 700, whilst making connection pods and connection leads in the coplanar technology outlined previously in this text. The chips would then be attached to the pods and/or leads by soldering.

If send and/or receive electronics 710, 720, are integrated into the back layer 700, the antennas maybe accessed on baseband level or by means of a digital bus, shown as 730 in FIG. 7.

Another way of integrating send and/or receive electronics into the back layer 700 would be to form at least some of the components of those electronics, e.g. semi-conductors and discrete components, directly on the back layer by means of conventional methods for creating components in semi-conducting layers, such as, for example, doping of the semi-conducting layers if it is desired to form semi-conductor components such as transistors dipoles etc. directly in those layer, and standard etching techniques may be used for creating connections between the components.

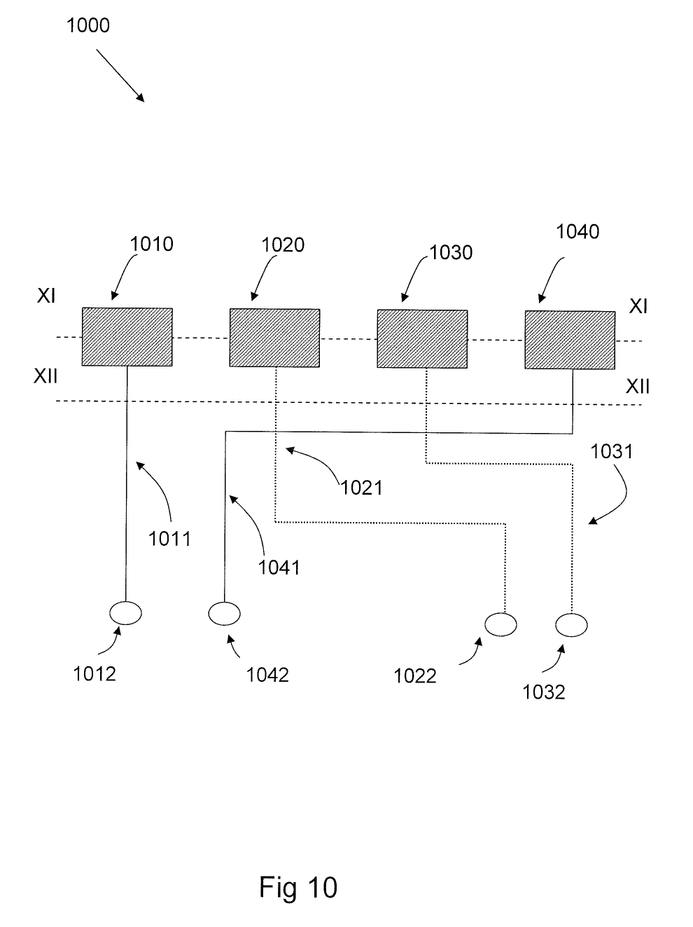

If electronics components are to be integrated into the back layer of the invention, as shown in FIG. 7, it may be necessary to have branches of the feeder network 630 or other conducting leads which cross each other. This may be the case if, for example, it is desired to connect more than one antenna element to more than one electronics component. A solution to letting conductors cross each other will be shown below in connection with the description of FIGS. 10-12.

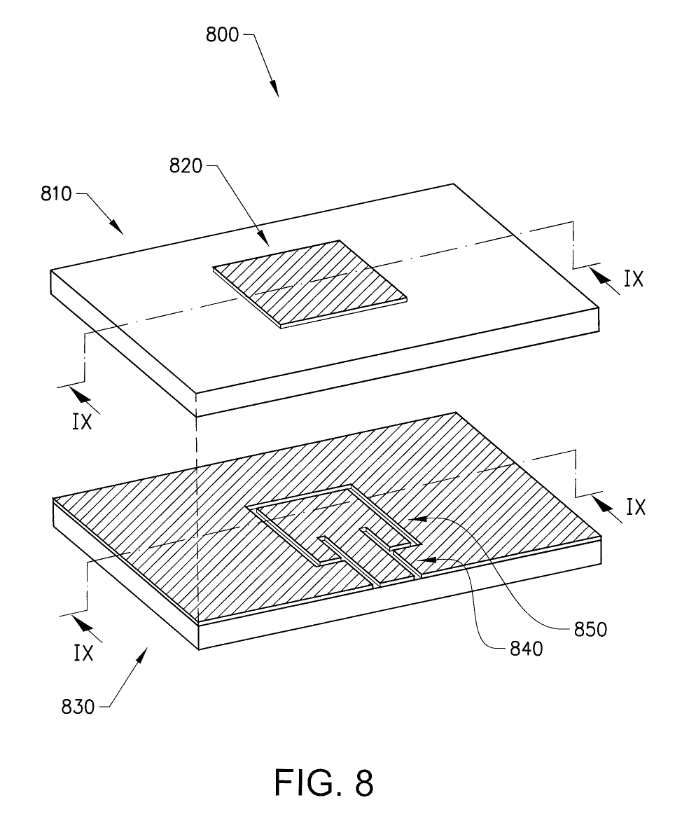

Another alternative of the present invention is shown in FIG. 8: the patches shown in FIGS. 4-7 may, instead of being used as “stand alone” radiation elements, be used to excite radiation elements arranged in another plane which is arranged spaced apart from the layer in which the excitation patches are arranged. This second layer may be spaced apart from the first layer of the excitation patches by mechanical means such as spacers, so that there is essentially only air in between the two layers, or as an alternative, a layer of a standard dielectric material can be arranged between the two layers.

Thus, as shown in FIG. 8, the device 800 comprises a first layer 810, which may be a layer of a non-conducting material, on which there is arranged one or more radiating antenna patches 820 in a conducting material. These patches 820 are suitably but not necessarily arranged on the layer 810 by means of etching.

In addition to the layer 810, the device or enhanced back layer 800 of the device also comprises a second layer 830, which is arranged essentially in parallel to the first layer 810, but spaced apart from it, as described above.

This second layer 830 comprises one or more patches 850 as described in connection with FIGS. 4-7 above, with a waveguide feed 840, which is also designed according to the principles described above.

The first 810 and second 830 layers are not only arranged essentially in parallel to each other, but also so that the exciting patch 850 may excite the patch 820 of the first layer.

Naturally, the first and second layers of the invention can comprise more than one pair of exciting/radiating patches, the number of such pairs can be varied more or less arbitrarily.

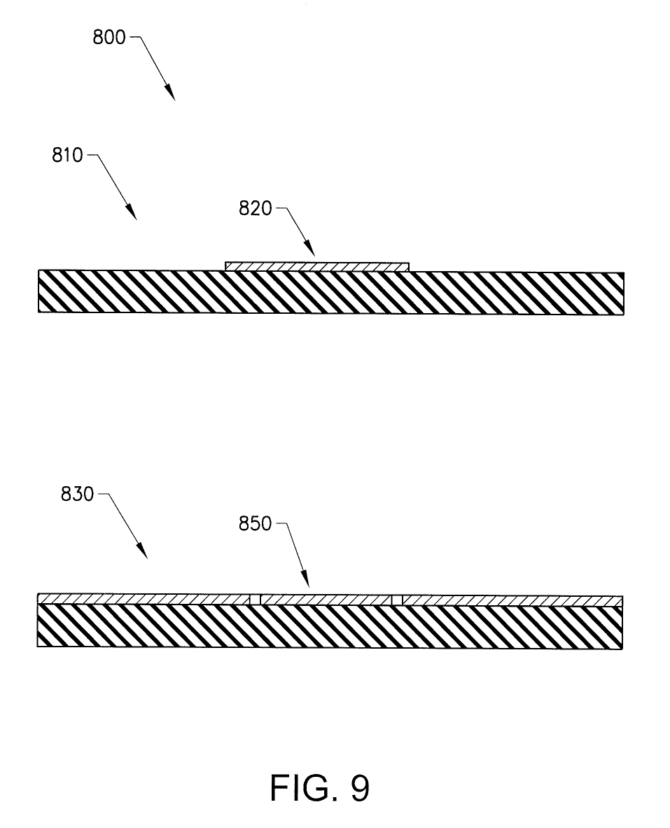

FIG. 9 shows a cross section of a version 900 of the design of FIG. 8, taken along the line IX-IX shown in FIG. 8. As can be seen in FIG. 9, the design 900 comprises the first 810 and second 830 planes of FIG. 8, spaced apart by conventional non-conducting means (not shown in FIG. 9) such as spacers or dielectric layers. In addition, the first layer comprises the antenna element c 820 shown in FIG. 8. The antenna element 820 is fed by the patch 850 of FIG. 8.

As is also shown in FIG. 9, the patch 850 is surrounded by two slots, thus making it a co-planar element.

FIG. 10 shows a front view of another embodiment 1000 of the invention, As shown, this embodiment 1000 comprises four radiation elements 1010, 1020, 1030, 1040, with respective feed lines 1011, 1021, 1031, 1041, which can be accessed at access points 1012, 1022, 1032, 1042.

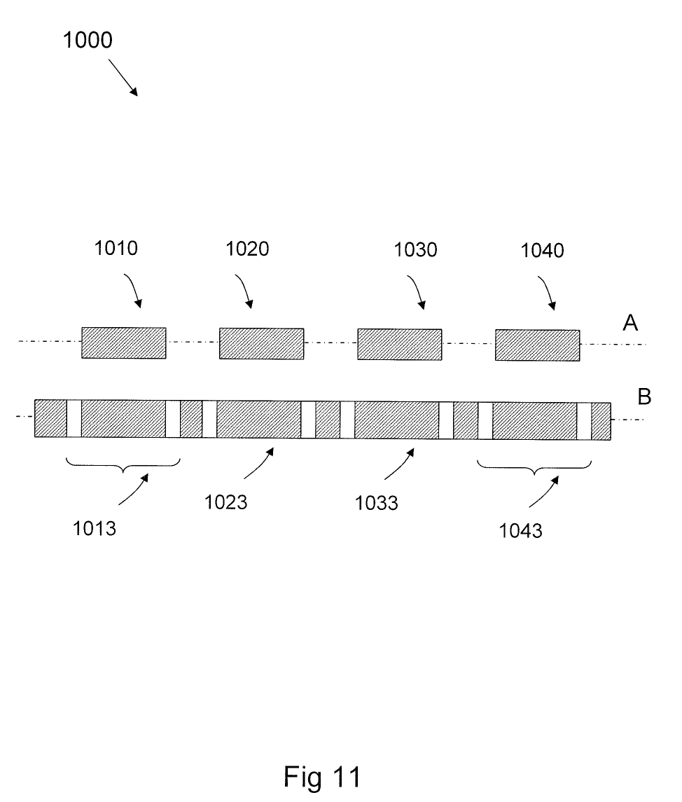

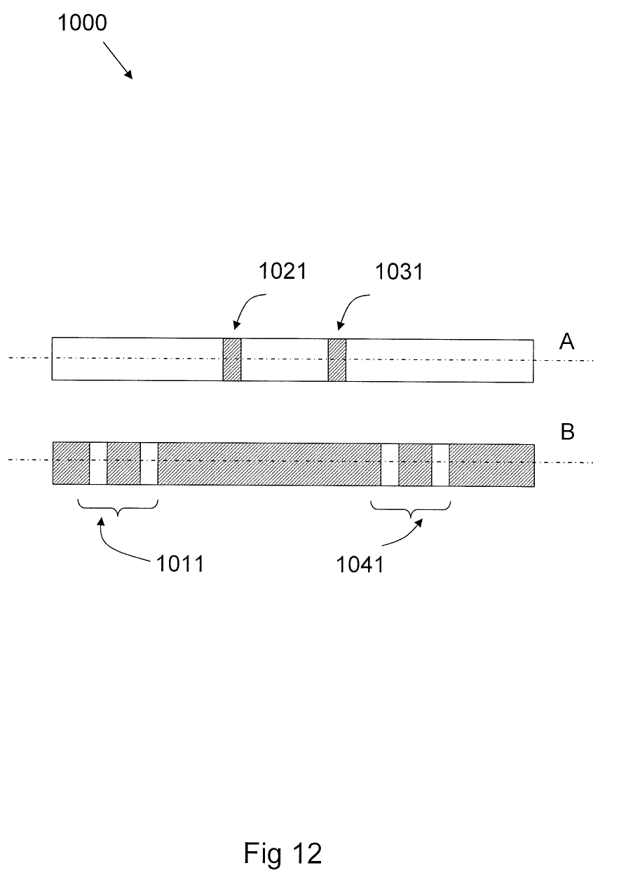

As seen in FIG. 10, the feed lines 1011, 1021, 1031, 1041, cross each other. How this can be accomplished will be shown in FIGS. 11 and 12, which show cross-sections of the device 1000 along the lines XI (FIG. 11) and XII (FIG. 12) shown in FIG. 10. However, before embarking on a description of those figures, it can be pointed out that the radiation elements 1010 and 1040 are excited by patches which terminate the feed lines 1011 and 1041, said feed lines 1011, 1041, and their exciting patches being designed in the co-planar technology which has been described previously in this text.

The exciting patches and the coplanar feed lines 1011, 1041, are arranged in a plane below (as seen “into” the paper of FIG. 10) the radiation elements, which will be show in FIGS. 11 and 12.

The radiation elements 1020, 1030 with their feed lines 1021 and 1031 are designed in microstrip technology, which is a technology well known to those skilled in the field, and which utilizes a conductor placed at a certain distance from a conducting ground plane. The feed lines 1021, 1031 of the radiation elements 1020, 1030, are located in the same plane as the radiation elements, and the radiation elements 1020, 1030, have a patch placed below them in order to increase the bandwidth of the radiation elements.

Thus, FIG. 11 shows the device 1000 of FIG. 10 in a cross section along the line XI-XI shown in FIG. 10. In FIG. 11, the patches which excite the radiation elements 1010, 1040, and which terminate the feed lines 1011, 1041 are shown as 1013 and 1043, surrounded by isolating slots.

The microstrip patches 1020 and 1030 are also shown in FIG. 11, with the aforementioned patches 1023, 1033, arranged below them, which is done in order to increase the bandwidth of the radiation elements 1020, 1030.

In order to facilitate comparison with FIG. 12, two lines, A and B are shown in FIG. 11, with the two lines intended to show different layers of the device 1000.

FIG. 12 shows the device 1000 of FIG. 10 in a cross section along the line XII-XII shown in FIG. 10. Here, in the “B-layer” we see the feed lines 1011 and 1041, and, as mentioned previously, the feed lines 1011 and 1041 are designed in the co-planar technique described above, something which can be seen clearly in FIG. 12, since each of the feed lines 1011 and 1041 exhibits a centre strip surrounded by a slot on each side.

In FIG. 12, in the “A-layer”, the feed lines 1021 and 1031 are also shown. As mentioned, these feed lines are designed in so called microstrip technology, in which there is a conductor placed at a distance from a ground plane. The feed lines 1021, 1031 are designed so that their conductor is placed in a separate layer, i.e. the “A-layer”, at a distance from the “B-layer” in which the co-planar waveguide feed lines 1011 and 1041 are arranged, so that the conducting plane in which the co planar waveguides are arranged can serve as ground plane for the microstrip lines 1021 and 1031.

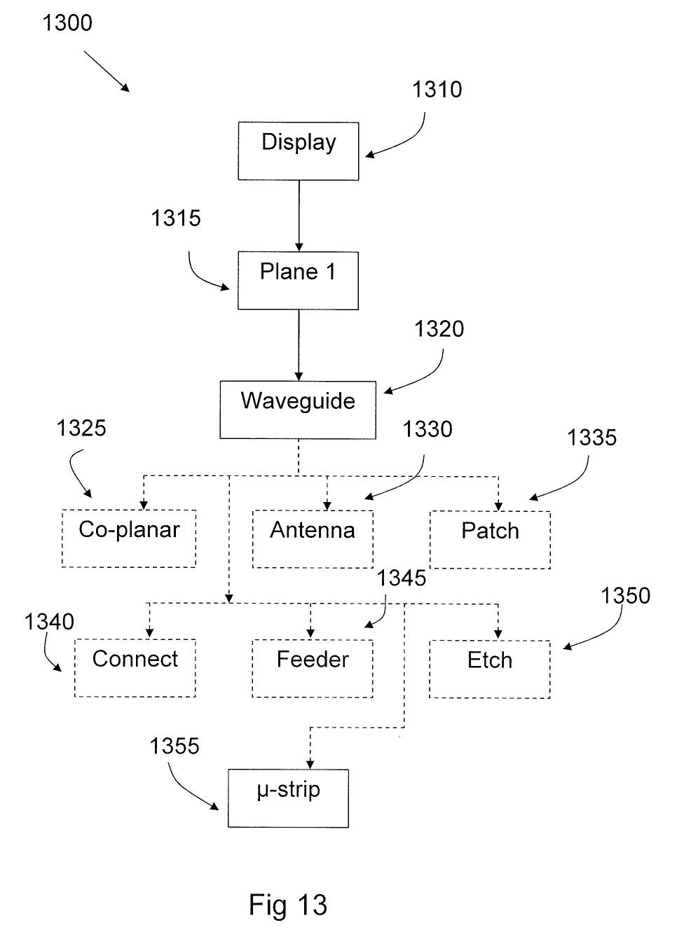

FIG. 13 shows a rough flow chart of a method 1300 of the invention. Steps which are options or alternatives are shown with dashed lines. Thus, the method 1300 of the invention is a method for assembling a movable part for an electronic device such as the one 100 shown in FIG. 1, i.e. a device which comprises at least two parts which can be moved in relation to each other, and the method comprises the step of arranging in said movable part a display, as shown in step 1310, for the electronic device, and also comprises arranging a first conducting plane, “Plane 1”, as shown in step 1015, a plane which is arranged in or adjacent to the display.

As indicated in step 1320, the method also comprises arranging a waveguide in the first conducting plane.

Step 1325 indicates that the waveguide may be a so called co-planar waveguide, i.e. a waveguide which comprises a central strip of conducting material surrounded by slots on both sides.

As shown in step 1340, the waveguide can be arranged in the first conducting plane so that a connection is obtained between an antenna which is attached to the movable part and a contact for a send and/or receive module.

Step 1330 indicates that the first conducting plane may additionally be made to comprise at least one antenna element which the waveguide in the conducting plane connects to.

The “antenna step” 1330 is also meant to indicate that according to the inventive method, the first conducting plane may be made to comprise a plurality of antenna elements. In such a case, the inventive waveguide can be formed into a feeder network, so that the antenna elements may be accessed from a common point in the first conducting plane.

Step 1335 shows that at least one of the antenna element(s) may be made as a patch antenna of rectangular, circular or oval shape.

One method for making the antenna elements is indicated in step 1050, which shows that the antenna element or elements can be etched into the first conducting plane.

Step 1355 shows that micro strip technology may be used in the method of the present invention, in which case the movable part is made to also comprise a second conducting plane, which is arranged adjacent to the first conducting plane, so that a radiation element in the first conducting plane can excite an antenna element in the second conducting plane. In this way, the movable part is made to comprise a micro strip antenna, formed by the first and second planes.

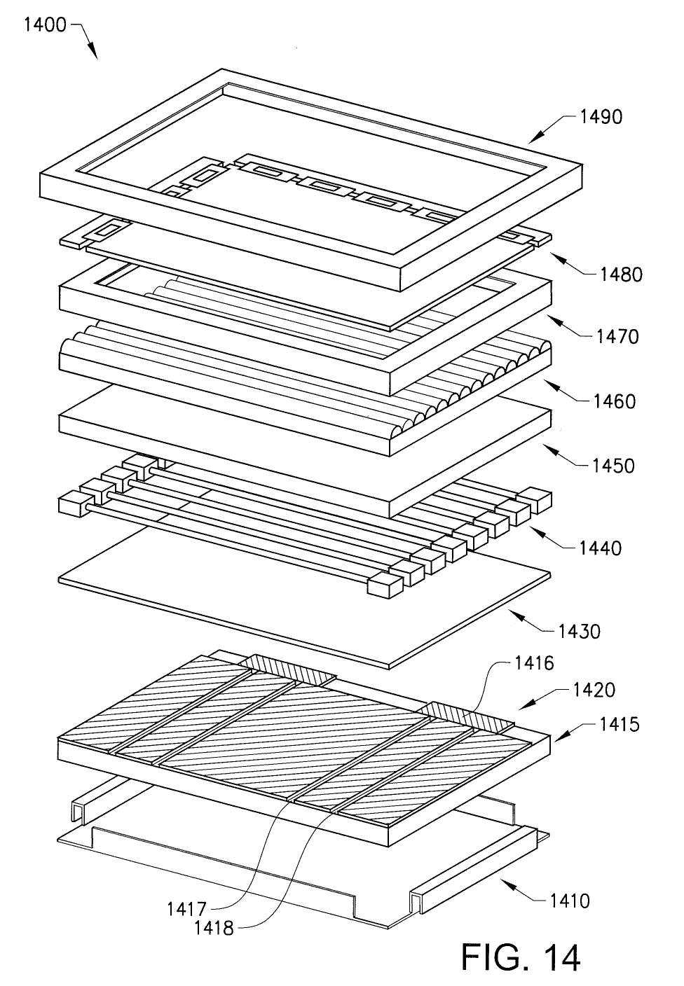

FIG. 14 shows an exploded view of a display 1400 for a portable computer in which a “rear plate” of the invention is used. The layers or plates 1410 and 1430-1490 are used for the display and will thus not be explained here. However, the display 1400 also includes a conducting layer 1420, which is used for the invention. As shown in FIG. 14, in the layer 1420 there are two co-planar waveguides formed, the grooves or slits of one being shown as 1417 and 1418. Each of the co-planar waveguides connects to an antenna, one of which is shown as 1416 in FIG. 14. The antennas may be formed in the conducting layer, in one of the ways described previously in this description, or they can be arranged in connection to the conducting layer, which is the alternative that is shown in FIG. 14.

In addition, as shown in FIG. 14, the conducting layer 1420 may rest on a layer of non-conducting material 1415, if it is desired to add stability to the layer 1420.

The invention is not limited to the examples of embodiments described above and shown in the drawings, but may be freely varied within the scope of the appended claims. For example, other kinds of waveguides than co-planar may be formed in a conducting plane of the invention, such as for example so called slot lines, which, as the name implies, comprise only a slot, as opposed to the co-planar waveguide's conducting strip surrounded by two slot lines.

1. A movable part for an electronic device which comprises at least two parts which can be moved in relation to each other, said movable part comprising a display for the electronic device as well as a first conducting plane which is comprised in the display or located adjacent to the display, the movable part being characterized in that the first conducting plane comprises a waveguide.

2. The movable part of claim 1, in which the waveguide is a co-planar waveguide that comprises a central strip of conducting material surrounded by slots on both sides.

3. The movable part of claim 1, in which the waveguide is used to obtain a connection between an antenna which is attached to the movable part and a send and/or receive module.

4. The movable part of claim 1, in which the first conducting plane additionally comprises at least one antenna element to which the waveguide connects.

5. The movable part of claim 4, comprising a plurality of antenna elements, and in which the waveguide is formed into a feeder network, so that the antenna elements may be accessed from a common point in the first conducting plane.

6. The movable part of claim 4, in which at least one of the antenna elements is a patch antenna of rectangular, circular or oval shape.

7. The movable part of claim 4, in which the antenna element or elements are etched into the first conducting plane.

8. The movable part of claim 1, further comprising a second conducting plane arranged adjacent to the first conducting plane, so that a radiation element in the first conducting plane acts so as to excite an antenna element in the second conducting plane, so that the movable part comprises a micro strip antenna, formed by the first and second planes.

9. The movable part of claim 1, being a movable part implemented in one of a group consisting of:
A portable computer, a “laptop” computer,
A personal digital assistant, a “PDA”,
A cellular telephone.

10. A method for assembling a movable part for an electronic device which comprises at least two parts which can be moved in relation to each other, the method comprising arranging in said movable part a display for the electronic device as well as arranging a first conducting plane in or adjacent to the display, the method being characterized in that it comprises arranging in the first conducting plane a waveguide.

11. The method of claim 10, according to which the waveguide is a co-planar waveguide that comprises a central strip of conducting material surrounded by slots on both sides.

12. The method of claim 10, according to which the waveguide is arranged in the first conducting plane so that a connection is obtained between an antenna which is attached to the movable part and a send and/or receive module.

13. The method of claim 10, according to which the first conducting plane is additionally made to comprise at least one antenna element to which the waveguide connects.

14. The method of claim 13, according to which the first conducting plane is made to comprise a plurality of antenna elements, and according to which the waveguide is formed into a feeder network, so that the antenna elements may be accessed from a common point in the first conducting plane.

15. The method of claim 13, according to which at least one of the antenna elements is made as a patch antenna of rectangular, circular or oval shape.

16. The method of claim 13, according to which the antenna element or elements are etched into the first conducting plane.

17. The method of claim 10, according to which the movable part is made to additionally comprise a second conducting plane which is arranged adjacent to the first conducting plane, so that a radiation element in the first conducting plane can excite an antenna element in the second conducting plane, by means of which method the movable part is made to comprises a micro strip antenna, formed by the first and second planes.
